(19) United States
(12) Patent Application Publication
(10) Pub. No.: US 2017/0274452 A1
(43) Pub. Date: Sep. 28, 2017

(54) POWDER FOR SINTERING AND SINTERED BODY

(71) Applicant: DAIDO STEEL CO., LTD., Nagoya-shi (JP)

(72) Inventors: Iwane NAGASE, Nagoya-shi (JP); Kiyoshi Yanagawa, Nagoya-shi (JP); Tomomi Yamamoto, Tokyo (JP); Tetsuya Kondou, Nagoya-shi (JP); Takashi Kinoshita, Tokyo (JP); Jun Noda, Tokyo (JP); Ryousuke Kaneko, Nagoya-shi (JP)

(21) Appl. No.: 15/464,170

(22) Filed: Mar. 20, 2017

(30) Foreign Application Priority Data
Mar. 28, 2016 (JP) 2016-063140

(51) Int. Cl. B22F 1/00; C01F 7/02; C01F 5/02; B22F 7/00; C01F 17/00; C01F 11/02; C01G 23/047; B22F 3/16; C01B 33/18; C01G 25/02

(52) U.S. Cl. CPC B22F 1/0003; C01B 33/18; C01F 7/02; C01F 5/02; C01G 25/02; C01F 17/0043; C01F 11/02; C01G 23/047; B22F 3/16; B22F 7/008; B22F 1/0059; C01P 2004/64; C01P 2004/62; B22F 2301/35; B22F 2998/10

(57) ABSTRACT

The present invention relates to a powder for sintering containing a mixture of a metal powder and metal oxide particles having an average particle diameter of 5 nm or more and 200 nm or less, and to a sintered body.

### TECHNICAL FIELD

The present invention relates to a powder for sintering and a sintered body and more specifically relates to a powder for sintering containing a metal powder as a main component and used for producing a sintered body, and a sintered body produced by using such a powder for sintering.

### BACKGROUND ART

A sintered body obtained by molding a metal powder into a predetermined shape and then sintering the powder is used as a material for producing a metal part such as a machine part. In this case, in order to process the sintered body into a metal part having a predetermined shape, machining such as cutting is performed.

The composition of a powder for sintering as a raw material has been studied in view of enhancing the machinability of the sintered body. For example, Patent Document 1 discloses a free-cutting sintered material obtained by adding a non-metal powder of glass, boron nitride, talc, or the like to a metal powder, mixing the materials, and sintering the mixture. As the non-metal powder, a powder having a particle diameter of from about 5 to 100 μm is used.

In addition, Patent Document 2 discloses the use of a powder containing MnS, Te or a Te compound, and/or Se or a Se compound as an auxiliary powder for improving machinability and/or improving wear resistance for an iron-based powder or an steel-based powder.

Patent Document 3 discloses a powder composition containing an iron-based powder and a powdered machinability-improving additive made of phyllosilicate. Examples of the additive made of phyllosilicate include a plurality of composite compounds containing Al and Si. The particle diameter of the additive is disclosed as preferably less than 50 μm, and also disclosed that in the case of less than 1 μm, it may be difficult to obtain a uniform powder mixture.
Patent Document 1: JP-A-563-93842
Patent Document 2: JP-T-H05-507118
Patent Document 3: JP-T-2012-513538

### SUMMARY OF THE INVENTION

In the case where particles as a free-cutting component are mixed in a powder for sintering as a raw material in order to improve the machinability of a sintered body, when the particles have a particle diameter of micron order as described in Patent Documents 1 and 3, the particles in the sintered body are likely to function as a starting point of damage such as breaking. In addition, when MnS or the like is added to a powder for sintering as described in Patent Document 2, high effect of improving machinability can be obtained but MnS or the like is likely to be corroded by salt water or the like and the corrosion resistance of a sintered body is therefore deteriorated.

An object of the present invention is to provide a powder for sintering containing a metal powder as a main component and capable of achieving high machinability and suppressing breaking and corrosion in a sintered body to be obtained, and to provide such a sintered body.

In order to achieve the above-mentioned object, a powder for sintering according to the present invention is a powder containing a mixture of a metal powder and metal oxide particles having an average particle diameter of 5 nm or more and 200 nm or less.

Here, the metal oxide particles may contain at least one metal oxide selected from the group consisting of Al₂O₃, MgO, ZrO₂, Y₂O₃, CaO, SiO₂, and TiO₂, as a main component. In addition, the metal oxide particles may be added in an amount of 0.03% by mass or more and 0.7% by mass or less in the powder for sintering. The metal oxide particles may be made of a single metal oxide having a purity of 90% by mass or higher.

A sintered body according to the present invention is a sintered body obtained by sintering a compact of the above-described powder for sintering.

The powder for sintering according to the present invention contains nanosized metal oxide particles added to a metal powder and thus, can be used to produce a sintered body having high machinability. In addition, the metal oxide particles in the sintered body are less likely to function as a starting point of damage such as breaking. Furthermore, the metal oxide particles are less likely to be corroded and thus the corrosion resistance of the sintered body is not impaired.

Here, in the case where the metal oxide particles contain at least one metal oxide selected from the group consisting of Al₂O₃, MgO, ZrO₂, Y₂O₃, CaO, SiO₂, and TiO₂, as a main component, since the nanoparticles of the metal oxide have high dispersibility and chemical stability, the sintered body can achieve excellent free-cutting properties and corrosion resistance. In addition, nanosized particles in which the particle diameter and the particle shape are satisfactorily controlled can be used at a low cost.

In addition, in the case where the amount of the metal oxide particles added in the powder for sintering is 0.03% by mass or more and 0.7% by mass or less, it is possible to achieve sufficiently high free-cutting properties and it is easy to avoid an increase in cutting resistance in the sintered body.

In the case where the metal oxide particles are made of a single metal oxide having a purity of 90% by mass or higher, variation in machinability and strength due to the presence of impurities is less likely to occur in the sintered body. In addition, unintended change such as melting, softening or a chemical reaction is less likely to occur at the time of sintering and a substance giving an environmental load is less likely to be discharged.

Since the sintered body according to the present invention is obtained by using a powder for sintering containing a mixture of nanosized metal oxide particles and a metal powder as a raw material, the sintered body has excellent machinability. In addition, the sintered body is less likely to suffering from damage such as breaking occurring with additive particles as a starting point and has excellent corrosion resistance.

### BRIEF DESCRIPTION OF THE DRAWINGS

FIG. 1 is a diagram illustrating an evaluation method of a corner flank wear width and illustrating a drill blade edge portion.

FIG. 2 is a transmission electron microscope image of a sintered body produced by using a powder for sintering containing SiO₂ nanoparticles.

### MODES FOR CARRYING OUT THE INVENTION

Hereinafter, a powder for sintering and a sintered body according to embodiments of the present invention will be described in detail.

A powder for sintering according to an embodiment of the present invention will be molded into a predetermined shape by press-molding or the like, and sintered to be formed into a sintered body. The sintered body is subjected to machining such as cutting, to be formed into a metal part such as a machine part. A sintered body according to an embodiment of the present invention includes a sintered body obtained through molding and sintering, as well as a metal part obtained through machining.

### (Powder for Sintering)

The powder for sintering according to an embodiment of the present invention is obtained by mixing a metal powder and metal oxide particles as free-cutting components. The powder for sintering preferably further contains a lubricant.

### (Metal Powder)

The metal powder may be made of a single metal or a metal alloy. From the viewpoint of exhibiting such a property as high strength in the sintered body, the metal powder is preferably made of an alloy, and the type of the alloy is not particularly limited. However, from the viewpoint of obtaining a sintered body having high strength and high corrosion resistance, stainless steels such as SUS304(L), SUS434(L), SUS316(L), SUS410(L), and SUS329J1 can be suitably used. Metal powders made of iron-based alloys other than stainless steels and copper-based alloys can be also suitably used as materials for obtaining a sintered body having high strength.

The particle diameter of the metal powder is not particularly specified and for example, a powder having a particle diameter in a wide range of from 1 to 1,000 μm can be used. However, from the viewpoint of uniformity of mixing with the metal oxide particle, versatility and the like, the particle diameter of the metal powder is preferably 30 μm or more and 150 μm or less. In addition, as the metal powder, powders produced by various methods such as a water spray method, a gas atomization method, a melt spinning method, a rotary electrode method, and a reduction method can be used.

### (Metal Oxide Particle)

The metal oxide particles to be mixed as free-cutting components in the powder for sintering of the present invention are nanoparticles having an average particle diameter (volumetric basis) of 5 nm or more and 200 nm or less.

The fine particles of the metal oxide are dispersed in a sintered body to be obtained. Therefore, at the time of cutting, fraction resistance between a tool and the sintered body is reduced so that the machinability of the sintered body is improved. In particular, since the metal oxides have a small nanosized particle diameter, the particles of the metal oxide are highly dispersed in a sintered body and have a large specific area. Thus, a significant effect of improving in machinability due to a reduction of the fraction coefficient can be obtained. Furthermore, since the metal oxide particles have a small nanosized particle diameter, the metal oxide particles are less likely to function as a starting point of damage such as breaking in the sintered body. Since the breaking is less likely to occur, the material strength of the sintered body, typified by tensile strength, is increased. In addition, since the metal oxide is chemically stable and is less likely to be corroded, the metal oxide is less likely to serve as a factor for lowering the corrosion resistance of the sintered body.

The average particle diameter of the metal oxide particles is preferably 100 nm or less, further preferably 50 nm or less, and particularly preferably 20 nm or less. The smaller the particle diameter is, the higher the effect of improving machinability and avoiding damage such as breaking in the sintered body is exhibited. The reason for limiting the lower limit of the average particle diameter to be 5 nm is that it is difficult to industrially produce particles having a particle diameter of less than 5 nm. In the specification, unless otherwise particularly specified, the particle diameter refers to a primary particle diameter of the particles.

The particle diameter of the metal oxide particles can be estimated by a known particle diameter measuring method such as particle size distribution measurement by laser diffraction, or image analysis with a transmission electron microscope (TEM). In general, when an image analysis with TEM is applied to fine particles having a particle diameter of 100 nm or less, the particle diameter thereof can be accurately evaluated. For the average particle diameter, a D50 value may be adopted.

The metal oxide particles may have any shape such as spherical shape, polyhedral shape such as cube, rod-like shape, and irregular shape. However, a spherical shape is particularly suitable. Since the spherical nanoparticles are less likely to aggregate and are highly dispersed in the metal powder, a particularly high effect of improving machinability and effect of preventing breaking in the sintered body can be obtained. The shape of the metal oxide particles can be evaluated by using TEM. In the case where the metal oxide particles have shapes other than a spherical shape, the particle diameter may be evaluated as a spherical volume equivalent diameter.

It is preferable that the metal oxide particles are dispersed in the powder for sintering and in the sintered body in a state of a single particle without aggregating. This is because high effects of improving the machinability and avoiding damage such as breaking of the sintered body are exhibited. However, as long as sufficiently high effects of improving the machinability and avoiding damage such as breaking are obtained, the powder may partially include aggregates and for example, particles of about 20% or less of the total number of the metal oxide particles may aggregate. In addition, in the case where the powder includes aggregates, it is preferable that the whole particle diameter of the aggregate is within a range of 200 nm or less, which is defined as the value of the upper limit of the primary particle diameter of the metal oxide particles.

The type of the metal oxide for constituting the metal oxide particles is not particularly limited. However, it is preferable to use a metal oxide which has high chemical stability, and does not substantially cause modification such as melting or softening, chemical reaction, and changes such as aggregation at temperature at the time of sintering (e.g., from 1,000° C. to 1,300° C.). The metal oxide may be a single metal oxide or a composite metal oxide but from the viewpoint of chemical stability at a high temperature and production costs, a single metal oxide is preferable.

It is particularly preferable that the metal oxide particles are made of a single metal oxide having a purity of 90% by mass or higher and more preferably 97% by mass or higher. In the case where the metal oxide particles have such a high purity, variation in machinability and material strength due to the presence of impurities is less likely to occur in the sintered body. In addition, unintended change such as a chemical reaction with other components contained in the particle materials or the like due to a high temperature at the time of sintering is less likely to occur. Here, examples of assumed other components include metal oxides (single metal oxide and/or composite metal oxide) other than the main component, impurities such as water or an organic solvent, and a surface treating agent derived from the production step. In the case where a large amount of impurities such as an organic substance is contained in the metal oxide particles, an environmental load substance may be discharged at the time of sintering.

As a suitable single metal oxide constituting the metal oxide particles, Al₂O₃, MgO, ZrO₂, Y₂O₃, CaO, SiO₂, and TiO₂ can be used. The nanoparticles of these metal oxides exhibit high dispersibility in the metal powder and are excellent in the effect of improving machinability. In addition, since they are also excellent in the chemical stability, modification such as corrosion is less likely to occur. The nanoparticles exhibit high stability at a high temperature and are less affected by sintering. In addition, for the nanoparticles of these metal oxides, good nanoparticles in which particle diameter and the particle shape are satisfactorily controlled can be produced at a low cost. In particular, SiO₂ is excellent in the respective properties.

The metal oxide particles may be surface-treated by an organic molecule or the like for the purpose of preventing aggregation and enhancing dispersibility. However, as described above, from the viewpoint of avoiding unintended change and discharge of an environmental load substance at the time of sintering, the metal oxide particles are preferably made of a metal oxide having a high purity. Even in the case where the metal oxide particles are surface-treated, the content of the surface treating agent is preferably controlled such that the purity of the metal oxide is within a range of 90% by mass or higher and preferably within a range of 97% by mass or higher. More preferably, the metal oxide particles may not be surface-treated. For example, in the case of using spherical SiO₂ particles, aggregation among the particles can be sufficiently avoided and the particles can be highly dispersed in the metal powder without performing a surface treatment.

Since the nanosized metal oxide particles have high dispersibility as described above and a large specific area, the effect of improving the machinability of the sintered body can be obtained by the addition of the metal oxide particles to the powder for sintering in a small amount. In the case where the amount of the metal oxide particles added in the powder for sintering is set to 0.03% by mass or more with respect to the total mass of the powder for sintering, the improvement in the machinability of the sintered body can be particularly effectively achieved. The amount of the metal oxide particles added is more preferably 0.05% by mass or more and particularly preferably 0.10% by mass or more. On the other hand, the addition of an excessive amount of the metal oxide particles may cause the generation of resistance in the sintered body at the time of cutting. In addition, the addition of an excessive amount of the metal oxide particles also causes a decrease in the material strength of the sintered body. In the case where the amount of the metal oxide particles added is set to 0.7% by mass or less, cutting resistance can be reduced and the material strength is likely to be secured. The amount of the metal oxide particles added is more preferably 0.50% by mass or less, and particularly preferably 0.20% by mass or less. One type of metal oxide particles may be used and a plurality of metal oxide particles having different composition, particle diameters, particle shapes, and the like may be used as a mixture.

As a method for producing the nanoparticles of the metal oxide, various methods are known and a known method may be appropriately applied herein to prepare metal oxide particles. For example, a chemical method such as a hydrothermal synthesis method, a sol-gel method, or an alkoxide method; a physical method such as an evaporation method, a sputtering method, and a pulverization method, and the like may be used. In addition, as a method for mixing the metal oxide particles with the metal powder, a double cone type or V cone type mixer or the like can be used. Even when the metal oxide particles aggregate at a certain degree of aggregation in the state before being added, the aggregation may be eliminated in a mixing step in some cases.

### (Lubricant)

The lubricant has a role of improving moldability, achieving high density, and securing mold lubricity at the time when the powder for sintering is press-molded. The lubricant is vaporized at the time of sintering and does not substantially remain in the sintered body.

As the lubricant, one known as a lubricant to be added to a conventional metal powder for sintering may be used. For example, metal soaps such as lithium stearate and zinc stearate, and amides such as ethylene-bis-stearic amide can be used.

The amount of the lubricant added is preferably 0.03% by mass or more with respect to the total mass of the powder for sintering. In the case where the amount is less than 0.03% by mass, there is a possibility that a sufficient lubrication action cannot be obtained or the density of the sintered body cannot be sufficiently increased. On the other hand, the amount of the lubricant added is preferably 0.7% by mass or less. In the case where the amount of the lubricant added is excessive, voids may be formed in the sintered body. As a method for adding the lubricant, the lubricant may be mixed together at the time when the metal powder and the metal oxide particles are mixed by using a double cone type or V cone type mixer or the like.

Components other than the lubricant may be added to the powder for sintering within a range of not deteriorating the machinability and not impairing corrosion resistance of the sintered body. Examples of such an additional component include iron powder, copper powder, carbon powder, and the like.

### <Sintered Body>

A sintered body according to an embodiment of the present invention is obtained by using the above-described powder for sintering as a raw material.

First, the powder for sintering described above is filled in a mold and is press-molded into a desired shape by using a hydraulic press machine or the like. Then, the obtained compact is subjected to sintering (heat treatment). The interfaces between the metal powder particles are fused by the sintering so that joining force can be improved. The sintering temperature depends on the composition of the metal powder. However, for example, in the case where the metal powder is made of stainless steel, the sintering temperature may be from 1,000° C. to 1,300° C. The sintering can be performed by a continuous type or batch type sintering furnace or the like. In addition, for the sintering atmosphere, vacuum, ammonia decomposition gas, hydrogen, nitrogen, argon, or the like can be employed.

The sintered body can be formed into a metal part having a desired shape through appropriate machining such as cutting. In the case where the metal powder is made of stainless steel, examples of the metal part to be produced include machine parts for automobiles and home electric appliances, and electric parts.

### EXAMPLES

Hereinafter, the present invention will be described in detail with reference to examples.

### (Test Method)

### (Production of Powder for Sintering and Sintered Body)

Each component shown in Tables 1, 2, 3, and 4 were mixed to prepare powders for sintering of Examples 1 to 35 and Comparative Examples 1 to 8. Except for Comparative Example 7, the free-cutting component was metal oxide particles and spherical particles whose surface was not treated were used.

A mold was filled with each of the obtained powders for sintering and press-molding was performed. As the mold, a columnar mold having a diameter of 11 mm (for machinability evaluation and tensile strength evaluation) or a diameter of 15 mm (for corrosion resistance evaluation) was used and the press load was set to 7 ton/cm². Then, the obtained compacts were dewaxed at 500° C. for 1 hour and then sintered at 1,170° C. for 1 hour. In this manner, sintered bodies of Examples 1 to 35 and Comparative Examples 1 to 8 were obtained.

### (Evaluation of Machinability)

The machinability of each sintered body was evaluated by a drilling test. For the evaluation, a drilling apparatus in accordance with JIS B 4313 (2008) was used. The drill blade was disposed to be vertical to the surface of the sintered body and cutting was performed at a distance of 27 mm under the following conditions.
Material of drill: SKH51 (diameter: 5 mm)
Cutting speed: V=30 m/min
Feeding speed: f=0.1 mm/rev
Cutting under dry condition

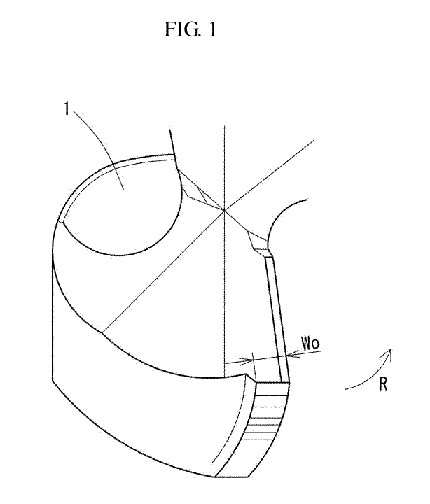

Thereafter, the drill blade edge was observed and a corner flank wear width was measured. The corner flank wear width was measured as a width (depth) of wear of the corner flank along a cutting direction R as indicated in a blade edge 1 and reference numeral Wo in FIG. 1. The test was performed three times and the accumulated value (total value) of the measured values of three times was adopted as the corner flank wear width.

### (Evaluation of Tensile Strength)

In order to evaluate difficulty of occurrence of breaking in each sintered body, a tensile strength test was performed in accordance with JIS Z 2241 (2011) and JIS Z 2550 (2000).

### (Evaluation of Corrosion Resistance)

A neutral salt spray test was performed on the sintered body in each of Examples and Comparative Examples in accordance with JIS Z 2371 (2015). After 48 hours had passed, the sintered body was visually observed to determine the presence or absence of corrosion and degree of corrosion. Then, the case where a free-cutting component was not added was taken as a reference and the comparison for degree of corrosion was conducted.

### (Confirmation of Dispersion State of Metal Oxide Particles)

In order to confirm the dispersion state of the metal oxide particles in the sintered body, the sintered body according to Example 17 was observed with TEM.

A sample for observation was prepared according to an extraction replica method. That is, the sintered body was mirror-polished and then was corroded with a vilella solution (10 mL of nitric acid, 20 to 30 mL of hydrochloric acid, and 20 to 30 mL of glycerin) to improve adhesion between SiO₂ particles and a carbon film. Carbon deposition was performed on the surface which had undergone polishing and corrosion and then a film peeling treatment with a vilella solution was performed. The obtained carbon film was washed with water and dried at 120° C. for 30 minutes or longer. The sample prepared as described above was introduced into vacuum. The measurement with TEM was performed by using “H9000-NAR” manufactured by Hitachi, Ltd. at an acceleration voltage of 300 kV and a magnification of 50,000 times.

### <Test Results>

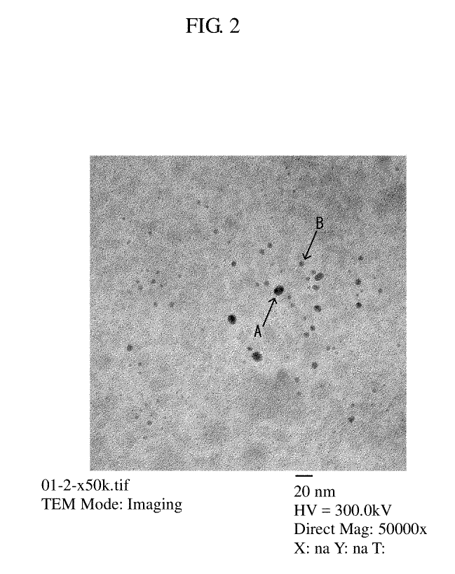

FIG. 2 shows a TEM observation image. In the image, as indicated by reference numerals A and B, the structures observed to be dark grey correspond to SiO₂ particles. The fact that these structures correspond to SiO₂ particles was confirmed by the fact that only the peaks of Si and O were observed in energy dispersive X-ray spectroscopy (EDS) except for the carrier-derived peak.

According to the image of FIG. 2, it was found that most SiO₂ particles are observed as a circular region having a particle diameter of about 10 nm as the particle indicated by reference numeral B and that the particles are dispersed in the sintered body while maintaining a spherical shape without aggregating. Although a small number of particles seems to aggregate as the particle indicated by reference numeral A, the aggregation diameter thereof is about 10 to 20 nm. As described above, it was confirmed that most SiO₂ particles are dispersed in the sintered body without aggregating and some aggregating particles are also dispersed to have an aggregation diameter of about 20 nm. The reason for SiO₂ particles being unevenly distributed in the whole image is that SiO₂ particles can enter only the grain boundary of the metal powder.

In Tables 1, 2, 3, and 4 below, the compositions of the powders for sintering as well as the evaluation results of corner flank wear width (machinability or cutability) and tensile strength (difficulty of the occurrence of breaking) of Examples 1 to 35 and Comparative Examples 1 to 8 are shown.

For the result of evaluation of corrosion resistance, corrosion did not occur within 48 hours in Examples 1 to 27 and Comparative Examples 2 and 3 in which various metal oxide particles were added to a powder of SUS304L, similar to the case of Comparative Example 1 in which the metal oxide particles were not added. That is, it was found that corrosion resistance was not deteriorated due to the addition of the free-cutting component. On the other hand, it was found that in Comparative Example 4 in which MnS was added, corrosion occurred and corrosion resistance was deteriorated compared to the case of Comparative Example 1. Also, in Examples 28 and 29 in which the compositions of the metal powders were changed, corrosion resistance was not deteriorated as compared to the case of Comparative Example 5 in which the free-cutting component was not added. It was found that in comparisons of Examples 30 and 31 and Comparative Example 6, Examples 32 and 33 and Comparative Example 7, and Examples 34 and 35 and Comparative Example 8, the same results were obtained and corrosion resistance was not deteriorated due to the addition of SiO₂ particles as the free-cutting component.

TABLE 1

| | | | | Free-cutting component | | | Corner | |
|---|---|---|---|---|---|---|---|---|
| | | Lubricant | | | Average | | flank | |
| | Type | | Addition | | particle | Addition | wear | Tensile |
| | of metal | | amount | | diameter | amount | width | strength |
| | powder | Type | [mass %] | Type | D50 [nm] | [mass %] | Wo [μm] | [MPa] |
| Comparative | SUS304L | Lithium stearate | 1.00 | Not added | — | — | 100 | 325 |
| Example 1 | | | | | | | | |
| Example 1 | SUS304L | Lithium stearate | 1.00 | SiO₂ | 50 | 0.03 | 44 | 324 |
| Example 2 | SUS304L | Lithium stearate | 1.00 | SiO₂ | 50 | 0.05 | 20 | 325 |
| Example 3 | SUS304L | Lithium stearate | 1.00 | SiO₂ | 50 | 0.10 | 21 | 323 |
| Example 4 | SUS304L | Lithium stearate | 1.00 | SiO₂ | 50 | 0.20 | 21 | 324 |
| Example 5 | SUS304L | Lithium stearate | 1.00 | SiO₂ | 50 | 0.50 | 27 | 322 |
| Example 6 | SUS304L | Lithium stearate | 1.00 | SiO₂ | 50 | 0.70 | 44 | 325 |
| Example 7 | SUS304L | Lithium stearate | 1.00 | SiO₂ | 50 | 1.00 | 70 | 280 |
| Example 8 | SUS304L | Lithium stearate | 0.30 | SiO₂ | 50 | 0.50 | 64 | 322 |
| Example 9 | SUS304L | Lithium stearate | 0.50 | SiO₂ | 50 | 0.50 | 29 | 326 |
| Example 10 | SUS304L | Lithium stearate | 1.50 | SiO₂ | 50 | 0.50 | 27 | 325 |
| Example 11 | SUS304L | Lithium stearate | 2.00 | SiO₂ | 50 | 0.50 | 54 | 324 |

TABLE 2

| | | | | Free-cutting component | | | Corner | |
|---|---|---|---|---|---|---|---|---|
| | | Lubricant | | | Average | | flank | |
| | Type | | Addition | | particle | Addition | wear | Tensile |
| | of metal | | amount | | diameter | amount | width | strength |
| | powder | Type | [mass %] | Type | D50 [nm] | [mass %] | Wo [μm] | [MPa] |
| Example 12 | SUS304L | Zinc stearate | 1.00 | SiO₂ | 50 | 0.50 | 27 | 323 |
| Example 13 | SUS304L | Aluminum stearate | 1.00 | SiO₂ | 50 | 0.50 | 27 | 322 |
| Example 14 | SUS304L | Calcium stearate | 1.00 | SiO₂ | 50 | 0.50 | 28 | 322 |
| Example 15 | SUS304L | Ethylene-bis-stearic | 1.00 | SiO₂ | 50 | 0.50 | 26 | 324 |
| | | amide | | | | | | |
| Example 16 | SUS304L | Lithium stearate | 1.00 | SiO₂ | 5 | 0.50 | 27 | 325 |
| Example 17 | SUS304L | Lithium stearate | 1.00 | SiO₂ | 10 | 0.50 | 27 | 321 |
| Example 18 | SUS304L | Lithium stearate | 1.00 | SiO₂ | 30 | 0.50 | 27 | 322 |
| Example 19 | SUS304L | Lithium stearate | 1.00 | SiO₂ | 70 | 0.50 | 30 | 325 |
| Example 20 | SUS304L | Lithium stearate | 1.00 | SiO₂ | 100 | 0.50 | 35 | 324 |
| Example 21 | SUS304L | Lithium stearate | 1.00 | SiO₂ | 200 | 0.50 | 42 | 320 |
| Comparative | SUS304L | Lithium stearate | 1.00 | SiO₂ | 500 | 0.50 | 74 | 299 |
| Example 2 | | | | | | | | |
| Comparative | SUS304L | Lithium stearate | 1.00 | SiO₂ | 700 | 0.50 | 110 | 281 |
| Example 3 | | | | | | | | |

TABLE 3

| | | | | Free-cutting component | | | Corner | |
|---|---|---|---|---|---|---|---|---|
| | | Lubricant | | | Average | | flank | |
| | Type | | Addition | | particle | Addition | wear | Tensile |
| | of metal | | amount | | diameter | amount | width | strength |
| | powder | Type | [mass %] | Type | D50 [nm] | [mass %] | Wo [μm] | [MPa] |
| Example 22 | SUS304L | Lithium stearate | 1.00 | Al₂O₃ | 50 | 0.50 | 28 | 324 |
| Example 23 | SUS304L | Lithium stearate | 1.00 | MgO | 50 | 0.50 | 27 | 322 |
| Example 24 | SUS304L | Lithium stearate | 1.00 | ZrO₂ | 50 | 0.50 | 29 | 327 |
| Example 25 | SUS304L | Lithium stearate | 1.00 | Y₂O₃ | 50 | 0.50 | 30 | 329 |
| Example 26 | SUS304L | Lithium stearate | 1.00 | CaO | 50 | 0.50 | 27 | 321 |
| Example 27 | SUS304L | Lithium stearate | 1.00 | TiO₂ | 50 | 0.50 | 29 | 322 |
| Comparative | SUS304L | Lithium stearate | 1.00 | MnS | 5,000 | 0.50 | 47 | 325 |
| Example 4 | | | | | | | | |
| Comparative | SUS434L | Lithium stearate | 1.00 | Not | — | — | 107 | 296 |
| Example 5 | | | | added | | | | |
| Example 28 | SUS434L | Lithium stearate | 1.00 | SiO₂ | 50 | 0.20 | 31 | 293 |
| Example 29 | SUS434L | Lithium stearate | 1.00 | SiO₂ | 50 | 0.50 | 34 | 294 |

TABLE 4

| | | | | Free-cutting component | | | Corner | |
|---|---|---|---|---|---|---|---|---|
| | | Lubricant | | | Average | | flank | |
| | Type | | Addition | | particle | Addition | wear | Tensile |
| | of metal | | amount | | diameter | amount | width | strength |
| | powder | Type | [mass %] | Type | D50 [nm] | [mass %] | Wo [μm] | [MPa] |
| Comparative | SUS316L | Lithium stearate | 1.00 | Not | — | — | 104 | 311 |
| Example 6 | | | | added | | | | |
| Example 30 | SUS316L | Lithium stearate | 1.00 | SiO₂ | 50 | 0.20 | 30 | 307 |
| Example 31 | SUS316L | Lithium stearate | 1.00 | SiO₂ | 50 | 0.50 | 33 | 309 |
| Comparative | SUS410L | Lithium stearate | 1.00 | Not | — | — | 109 | 276 |
| Example 7 | | | | added | | | | |
| Example 32 | SUS410L | Lithium stearate | 1.00 | SiO₂ | 50 | 0.20 | 29 | 273 |
| Example 33 | SUS410L | Lithium stearate | 1.00 | SiO₂ | 50 | 0.50 | 35 | 274 |
| Comparative | SUS329J1 | Lithium stearate | 1.00 | Not | — | — | 103 | 381 |
| Example 8 | | | | added | | | | |
| Example 34 | SUS329J1 | Lithium stearate | 1.00 | SiO₂ | 50 | 0.20 | 33 | 384 |
| Example 35 | SUS329J1 | Lithium stearate | 1.00 | SiO₂ | 50 | 0.50 | 34 | 388 |

In Examples 1 to 7, SiO₂ particles having a particle diameter of 50 μm were added to a SUS304L powder and the amount of the particles added was changed. As compared to the case of Comparative Example 1 in which SiO₂ particles are not added, it is found that in each Example, the corner flank wear width was significantly reduced by adding SiO₂ particles, and the machinability was improved. Among these, in the case where the amount of the particles added was from 0.05% to 0.20% by mass (Examples 2 to 4), machinability was particularly enhanced. Regarding the tensile strength, that is, difficulty of the occurrence of breaking, as compared to the case of Comparative Example 1, in the case of Example 7 in which SiO₂ particles were added in an amount of 1.00% by mass, the tensile strength was slightly deteriorated. However, in Examples in which the amount of the particles added was smaller than that in Example 7 (Examples 1 to 6), the tensile strength was rarely changed due to the addition of SiO₂ particles. This result exhibits that the addition of nanosized metal oxide particles to the powder for sintering does not impair the corrosion resistance of the sintered body and does not significantly decrease the tensile strength (does not increase easiness of the occurrence of breaking), so that the machinability is enhanced.

In Examples 5 and 8 to 11, the amount of lithium stearate added as a lubricant was changed. As a result, in Examples in which the amount of the lubricant added was 1.50% by mass or less (Examples 5, and 8 to 10), the corner flank wear width was decreased and the machinability was enhanced. However, in the case where the amount of the lubricant added was 2.00% by mass (Example 11), the corner flank wear width was large and the machinability was deteriorated. It can be interpreted that this is because since the moldability of the powder for sintering is improved by the addition of the lubricant, the machinability of the sintered body is enhanced; but in the case where a large amount of the lubricant is added, the machinability is rather deteriorated due to the formation of voids at the time of sintering.

The type of the lubricant used was changed in Example 5 and Examples 12 to 15. When comparing these Examples, it is found that the machinability and the tensile strength of the sintered body rarely depend on the type of the lubricant.

In Examples 5 and 16 to 21, and Comparative Examples 2 and 3, the particle diameter of SiO₂ particles is changed. As compared to Comparative Examples 2 and 3 in which the particle diameter was more than 200 nm, in Examples 5 and 16 to 21 in which the particle diameter was 200 nm or less, the corner flank wear width was decreased and the machinability was enhanced. In addition, the tensile strength was increased and breaking was less likely to occur. Even among Examples 5 and 16 to 21, the smaller the particle diameter of SiO₂ particles was, the higher the machinability was.

In Examples 5 and 22 to 27, and Comparative Example 4, the type of the free-cutting component added was changed. In Comparative Example 4, MnS was used as the free-cutting component and the corrosion resistance of the sintered body was deteriorated due to easiness of corrosion of MnS. In contrast, in each Example in which various metal oxides were used as the free-cutting components, high corrosion resistance was obtained.

In Examples 1 to 27 and Comparative Examples 1 to 4, all metal powders were made of SUS304L but in the series of Comparative Example 5 and Examples 28 and 29, the series of Comparative Example 6 and Examples 30 and 31, the series of Comparative Example 7 and Examples 32 and 33, and the series of Comparative Example 8 and Examples 34 and 35, the type of each metal powder was changed. Regardless of the type of the metal powder, the results that the addition of SiO₂ particles decreased the corner flank wear width, enhanced the machinability, but did not impair the tensile strength and the corrosion resistance, as shown in the series of Comparative Example 1 and Examples 1 to 7, were obtained. Since the composition of each metal powder is different, the absolute values of the corner flank wear width and the tensile strength were different.

The embodiments of the present invention have been described in detail above. However, the present invention is not limited to the above embodiments and examples and various modifications can be made within a range not departing from the gist of the present invention.

The present application is based on the Japanese patent application No. 2016-063140 filed on Mar. 28, 2016, and the contents thereof are incorporated herein by reference.

### DESCRIPTION OF REFERENCE NUMERALS AND SIGNS

1 Drill blade edge
Wo Corner flank wear width
R Cutting direction

What is claimed is:

1. A powder for sintering comprising a mixture comprising:
a metal powder and
metal oxide particles having an average particle diameter of 5 nm or more and 200 nm or less.

2. The powder for sintering according to claim 1,
wherein the metal oxide particles comprise at least one metal oxide selected from the group consisting of Al₂O₃, MgO, ZrO₂, Y₂O₃, CaO, SiO₂, and TiO₂, as a main component.

3. The powder for sintering according to claim 1,
wherein the metal oxide particles is added in an amount of 0.03% by mass or more and 0.7% by mass or less in the powder for sintering.

4. The powder for sintering according to claim 1,
wherein the metal oxide particles is made of a single metal oxide having a purity of 90% by mass or higher.

5. A sintered body obtained by sintering a compact of the powder for sintering as described in claim 1.
